(19) United States
(12) Patent Application Publication
(10) Pub. No.: US 2026/0180931 A1
(43) Pub. Date: Jun. 25, 2026

(54) INFORMATION PROCESSING SYSTEM, INFORMATION PROCESSING METHOD AND TERMINAL

(71) Applicant: Genki WATANABE, Tokyo (JP)

(72) Inventor: Genki WATANABE, Tokyo (JP)

(21) Appl. No.: 19/420,843

(22) Filed: Dec. 16, 2025

(30) Foreign Application Priority Data
Dec. 19, 2024 (JP) 2024-223680
Sep. 30, 2025 (JP) 2025-162749

(51) Int. Cl. H04L 51/02; G06F 3/0482

(52) U.S. Cl. CPC H04L 51/02; G06F 3/0482

(57) ABSTRACT

Different conversational Artificial Intelligence agents may output different results and/or have access to different data or different training. A user can be provided with the AI agent which provides the most suitable, best, or desired results. There are a plurality of conversational AIs and the most suitable one can be selected automatically. There is a display indicating which of the plurality of conversational Ais is being used. If desired, the information can be transmitted and presented based on web pages and HTTP requests.

### CROSS-REFERENCE TO RELATED APPLICATIONS

This patent application is based on and claims priority pursuant to 35 U.S.C. § 119(a) to Japanese Patent Application Nos. 2024-223680 filed on Dec. 19, 2024, and 2025-162749, filed on Sep. 30, 2025, in the Japan Patent Office, the entire disclosure of each of which is hereby incorporated by reference herein.

### BACKGROUND

### Technical Field

The present invention relates to an information processing system, an information processing method, and a terminal.

### Related Art

Conventionally, computer systems have been devised that interact with users by automatically generating responses to messages such as questions from the user and outputting said responses.

### SUMMARY

The present disclosure includes an information processing system, comprising an information processing apparatus and a terminal. The information processing apparatus comprises first circuitry that transmits web content data to the terminal, the web content data to cause a display of a first web page and a second web page, the first web page displaying a first conversational AI identifiably as an interlocutor, wherein the web content data includes a first script which causes the terminal to transmit a message input in the first web page and a second script which causes the terminal to display information indicating that the interlocutor is switched; determines a second conversational AI to output an alternative response to the message in response to receiving a Hypertext Transfer Protocol (HTTP) request including the message from the terminal, the HTTP request being transmitted in response to execution of the first script; switches the interlocutor from the first conversational AI to the second conversational AI based on the message; and transmits an HTTP response, to the terminal, including the information indicating that the interlocutor is switched. The terminal comprising second circuitry that receives the web content data from the information processing apparatus; displays the first web page, based on the web content data, the first web page including the first conversational AI as the interlocutor in communication with a user among a plurality of types of conversational AIs; receives the message from the user via the first web page;
transmits the HTTP request including the message in response to executing the first script included in the web content data; receives the HTTP response from the information processing apparatus including the information indicating that the interlocutor is switched; and displays the second web page based on the web content data in response to executing the second script, the second web page including information indicating the interlocutor is switched.

The present disclosure described herein provides an information processing method comprising transmitting web content data to a terminal, the web content data to cause a display of a first web page and a second web page, the first web page displaying a first conversational AI identifiably as an interlocutor, wherein the web content data includes a first script which causes the terminal to transmit a message input in the first web page and a second script which causes the terminal to display information indicating that the interlocutor is switched; determining a second conversational AI to output an alternative response to the message, in response to receiving a Hypertext Transfer Protocol (HTTP) request including the message from the terminal, the HTTP request being transmitted in response to execution of the first script; switching the interlocutor from the first conversational AI to the second conversational AI based on the message; and transmitting an HTTP response, to the terminal, including the information indicating that the interlocutor switched

The present disclosure described herein provides a terminal comprising circuitry that displays a first web page display the a first conversational AI identifiably as an interlocutor; receives a message input by a user; determines a second conversational AI, which outputs appropriate response to the message better than response of the first conversational AI; switches the interlocutor from the first conversational AI to second conversational AI determined based on the message; and displays the second web page including information indicating the interlocutor switched.

### BRIEF DESCRIPTION OF THE DRAWINGS

A more complete appreciation of implementations of the present disclosure and many of the attendant advantages and features thereof can be readily obtained and understood from the following detailed description with reference to the accompanying drawings, wherein:

FIG. 1 is a diagram illustrating a configuration of an information processing system of the first implementation;

FIG. 2 is a block diagram illustrating a hardware configuration of the information processing apparatus 10 of the first implementation;

FIG. 3 is a block diagram illustrating a functional configuration of the information processing system of the first implementation;

FIG. 4 is a diagram illustrating an agent information storage unit 121;

FIG. 5 is a diagram illustrating a history information storage unit 123;

FIG. 6 is a sequence diagram illustrating the processing steps executed by the information processing system of the first implementation;

FIG. 7 is a diagram illustrating an interactive screen display at the start of interaction;

FIG. 8 is a diagram illustrating a final response information display;

FIG. 9 is a diagram illustrating the interactive screen display showing the switching of execution agents;

FIG. 10 is a diagram illustrating a sequence diagram illustrating an example of a processing procedure executed by the information processing system of the second implementation;

FIG. 11 is a diagram illustrating display of an interactive screen prompting the user to select whether to switch the execution agent;

FIG. 12 is a diagram illustrating functional configuration of a terminal 20 of the third implementation;

FIG. 13 is a sequence diagram illustrating processing procedure for screen transitions of the third implementation;

FIG. 14 is a diagram illustrating display of an execution agent selection screen;

FIG. 15 is a diagram illustrating display of the interactive screen 510 after message input;

FIG. 16 is a diagram illustrating display of the interactive screen 510 after inputting a second message;

FIG. 17 is a diagram illustrating functional configuration of a terminal 20 equipped with the functions of information processing apparatus 10.

### DETAILED DESCRIPTION

The disclosure of this specification is not intended to be limited to the specific terminology so selected and it is to be understood that each specific element includes all technical equivalents that have a similar function, operate in a similar manner, and achieve a similar result.

Referring now to the drawings, implementations of the present disclosure are described below. As used herein, the singular forms “a,” “an,” and “the” are intended to include the plural forms as well, unless the context clearly indicates otherwise. The term “connected/coupled” includes both direct connections and connections in which there are one or more intermediate connecting elements. For the sake of simplicity, identical or similar reference numerals denote identical or similar elements such as parts and materials having the same functions, and redundant descriptions thereof are omitted unless otherwise required.

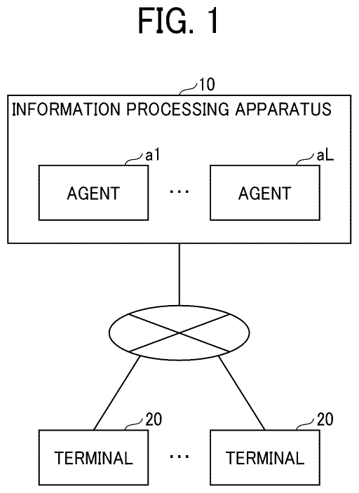

The following describes implementations of the present disclosure based on the drawings. FIG. 1 is an example diagram showing the configuration of an information processing system in the first implementation. In FIG. 1, one or more terminals 20 connect to the information processing apparatus 10 via a network such as a LAN (Local Area Network) or the Internet.

The information processing apparatus 10 is one or more computers functioning as multiple types of agents a1 to aL that interact with users. The agents are examples of conversational AI (“Artificial Intelligence” or “Artificial Intelligence Agents”) and appear to users as anthropomorphized virtual entities serving as dialogue partners (interlocutor). Conversation with the conversational AI (dialogue partner) refers to the process where a user inputs a message and a response is output in response. Conversational AI typically uses a large language model, although this is not mandatory. Specifically, the agent receives messages input by the user from the terminal 20, controls the generation of a response to that message, and outputs the response to the terminal 20.

Messages input by the user may be questions, instructions or requests, or other input information requiring a response. The response is text containing information corresponding to the message. The response may also be output as voice. Additionally, the agent may be referred to as an auto-response system, AI agent, digital clone, personalized AI, AI assistant, auto-response AI, dialogue partner, AI chatbot, companion, concierge, or virtual dialogue interface. The agent may also be a virtual human displayed on screen of the terminal 20 as a dialogue partner, represented as a 3D avatar modeled after a person.
In this implementation, the information processing apparatus 10 functions as multiple types of agents. These multiple types of the agents are distinguished by how they control the generation of responses to messages. Furthermore, the roles of the multiple types of the agents differ for each agent, and they are distinguished by purpose or application. For example, roles of the agents include inquiry (question-answering), comparison, classification, prediction, document generation, document supplementation, document evaluation, etc. The agents may be defined for each of these roles, or the agents corresponding to other roles may be defined.

A user can select an agent suitable for a desired purpose or application from among multiple agent types as an interlocutor which takes part in a dialogue or conversation. Interlocutor is some kind of partner of conversation or chat. Furthermore, the information processing apparatus 10 can automatically switch the agent serving as the interlocutor when it determines that changing to a more suitable agent is necessary based on the progress of the dialogue.

The terminal 20 is a device functioning as the user interface of the information processing system. PCs (Personal Computers), smartphones, or tablet devices, among others, may be used as terminal 20. Terminal 20 accepts message input from the user and transmits the message to the information processing apparatus 10. The terminal 20 also receives and displays the response generated by the information processing apparatus 10 in response to the message. The terminal 20 may output the received information via a projector, etc.

In this implementation, the information processing apparatus is assumed to be operated within a certain company (hereinafter referred to as “Company X”). Therefore, the users who can access the information processing apparatus 10 are individuals belonging to the Company X, such as its employees. The services provided by the information processing apparatus 10 may be publicly available as a cloud services.

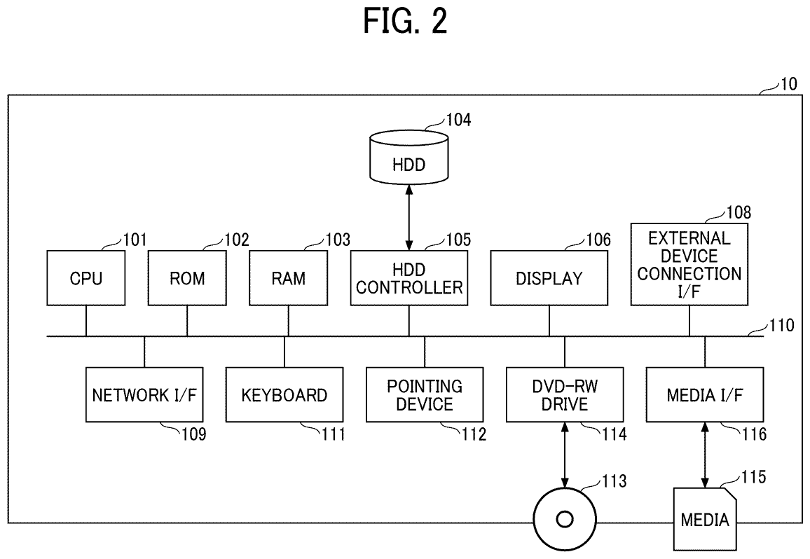

FIG. 2 is a diagram showing an example of the hardware configuration of the information processing apparatus 10 of the first implementation. As shown in FIG. 2, the information processing apparatus 10 includes a computer and includes a CPU (Central Processing Unit) 101, a ROM (Read Only Memory) 102, a RAM (Random Access Memory) 103, a HDD (Hard Disk Drive) 104, an HDD (Hard Disk Drive) controller 105, a display 106, an external device connection I/F (Interface) 108, a network I/F 109, a data bus 110, a keyboard 111, a pointing device 112, a DVD-RW (Digital Versatile Disk Rewritable) drive 114, and a media I/F 116.

The CPU 101 controls the operation of the entire information processing apparatus 10. The ROM 102 stores programs used to drive the CPU 101, such as the IPL (Initial Program Loader). The RAM 103 is used as the work area for the CPU 101. The HD 104 stores various data such as programs. The HDD controller 105 controls the reading or writing of various data to/from the HD 104 according to the control of the CPU 101. The display 106 displays various information such as cursors, menus, windows, characters, or images. The external device connection I/F 108 is an interface for connecting various external devices. In this case, the external devices include, for example, USB (Universal Serial Bus) memory devices and printers. The network I/F 109 is an interface for data communication using a communication network. The data bus 110 includes address buses, data buses, etc., for electrically connecting components such as the CPU 101.

The keyboard 111 is a type of input device equipped with multiple keys for inputting characters, numeric values, and various commands. The pointing device 112 is a type of input device used for selecting and executing various commands, selecting processing targets, moving the cursor, etc. The DVD-RW drive 114 controls the reading or writing of various data to and from the DVD-RW 113, an example of a removable recording medium. Note that the medium need not be limited to the DVD-RW 113; it may also be a DVD-R, etc. The media I/F 116 controls the reading or writing (storage) of data to and from the recording medium 115, such as flash memory.

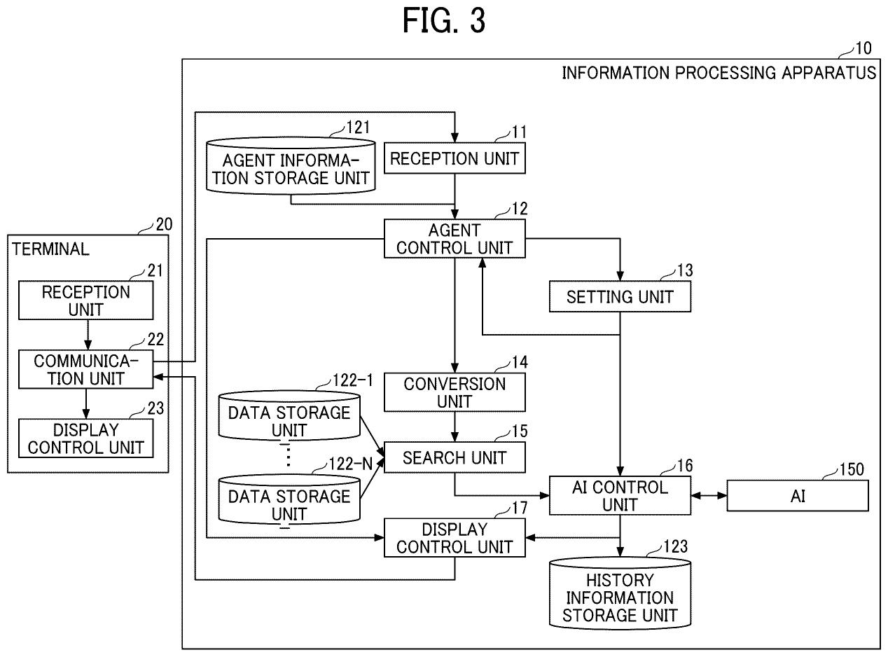

FIG. 3 is a diagram showing an example of the functional configuration of the information processing system of the first implementation. In FIG. 3, the information processing apparatus 10 has an AI 150.

The AI 150 is a machine learning model (e.g., a neural network) trained to generate text (hereinafter referred to as a “response”) corresponding to input text (hereinafter referred to as a “prompt”). The AI 150 may also be trained to output responses that include images or files. The AI 150 generates, for example, the text with the highest probability of occurrence as a response to a prompt based on its learning results. For example, a generative AI using a Large Language Model (LLM) may be employed as AI 150. The LLM is a machine learning model trained on natural language processing using vast amounts of text data. The LLM is used in many NLP (Natural Language Processing) tasks, such as generating responses to specific questions, automatically generating sentences, text summarization, translation, sentiment analysis, and many other NLP (Natural Language Processing) tasks. It can also be utilized for various applications such as education, entertainment, customer service, and product development. In this implementation, text including a message input by the user serves as the prompt. Note that the information processing apparatus 10 may not necessarily possess the AI 150. In this case, a publicly available generative AI on the internet or elsewhere may be used as the AI 150.

Here, machine learning refers to the technology enabling computers to acquire human-like learning capabilities, whereby a computer autonomously generates algorithms necessary for judgments such as data identification from pre-incorporated training data and applies these to new data to make predictions. The learning method for machine learning may be any of supervised learning, unsupervised learning, semi-supervised learning, reinforcement learning, or deep learning. Furthermore, a learning method combining these approaches is also acceptable; the specific learning method for machine learning is not restricted.

The agent receives messages from the user and employs Retrieval Augmented Generation (RAG) to generate responses from the AI 150 for those messages. It also executes processing to include text previously generated by the AI 150 (responses output by the AI 150 to prompts previously input to the AI 150) within the prompt. Specifically, the agent is a set of functional units that perform these processes. Specifically, the agent includes the following functional units: a reception unit 11, an agent control unit 12, a setting unit 13, a conversion unit 14, a search unit 15, an AI control unit 16, and a display control unit 17. Each of these units is implemented by processing executed by one or more programs installed on the information processing apparatus 10 on the CPU 101. The agent also utilizes the following as storage units: an agent information storage unit 121, multiple data storage units 122-1 to 122-N, and a history information storage unit 123. Each of these storage units can be implemented, for example, using the HD 104 or a storage device connectable to the information processing apparatus 10 via a network.

In this implementation, it has been explained that the information processing apparatus 10 functions as multiple types of the agents a1 to aL. However, the program functioning as the agent (hereinafter referred to as the “agent program”) is common to each agent. The agent program causes the information processing apparatus 10 to function as multiple types of the agents based on information pre-set for each agent (hereinafter referred to as “agent information”).

The reception unit 11 receives input from the user. For example, the reception unit 11 receives selection from the user of an agent (hereinafter referred to as the “execution agent”) to serve as the dialogue partner from among the multiple types of the agents a1 to aL. The reception unit 11 also receives input of messages for the execution agent. User input is performed on the terminal 20. Therefore, the reception unit 11 receives information corresponding to the input accepted by terminal 20 from terminal 20.

The agent control unit 12 controls switching of the execution agent. When the execution agent is selected by the user, the agent control unit 12 executes processing to make the selected agent a1 the execution agent. When automatically switching the execution agent according to the progress of the dialogue, the agent control unit 12 functions as an example of a determination unit that judges whether, among multiple types of the agents, there exists an agent a2 (a second agent) that can output a more appropriate or different response than the current execution agent (interlocutor) agent a1 (a first agent) for a message received by the reception unit 11. If the agent control unit 12 determines that a second agent exists, it functions as an example of a switching unit that switches the dialogue partner to the second agent. In the process of switching the execution agent from the first agent to the second agent, the agent control unit 12 inputs the agent information of the second agent, selected from the agent information stored for each agent in the agent information storage unit 121, into the setting unit 13. When automatically switching the execution agent based on the progress of the dialogue, the agent control unit 12 executes processing to automatically switch the execution agent based on the agent information stored for each agent in the agent information storage unit 121 and the message from the user.

The agent information of a particular agent, stored for each agent, includes text information indicating the role of the particular agent, identification information (hereinafter referred to as “data source ID”) of the data storage unit 122 corresponding to the particular agent, system prompts corresponding to the particular agent, and control rules corresponding to the particular agent.

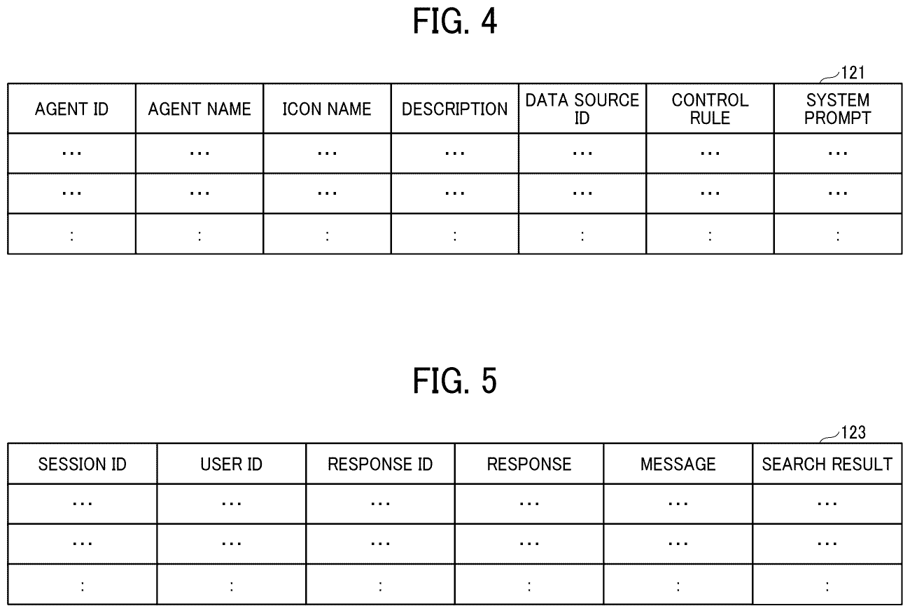

FIG. 4 is an example diagram of the agent information storage unit 121 which may be implemented as a table or database. As shown in FIG. 4, the agent information storage unit 121 pre-stores the agent information for each agent that is a selection candidate. The agent information includes the agent ID, agent name, icon name, description, data source ID, control rules, and system prompts.

The agent name is the name of the agent. The icon name is the filename of the icon representing the agent. The icon is displayed on the screen (dialog screen) used for interaction between the user and the agent. The description is text data describing role of the agent, etc., in natural language. The data source ID is the identification information for the data storage unit 122 that is a target of the agent to search. Two or more data storage units 122 may be designated as search targets. Control rules and system prompts are used for associating the AI control unit 16 with the agent on the information processing apparatus 10. Control rules and system prompts are defined for each agent, so multiple types of control rules and system prompts that differ from each other are prepared in advance. Even when multiple agents search the same data source, applying different control rules to each agent yields different responses from each agent. In other words, the agent's role is realized by the control rules and system prompts. For example, if one agent has the role of outputting query responses to user queries (questions), a description explaining that role, along with the control rules and system prompts to control the agent accordingly, are stored and associated with that query agent. For an analysis agent whose role is to analyze data and output analysis results based on user instructions, the description explaining this role, along with control rules and system prompts to control the agent accordingly, are stored associated with that analysis agent.

The system prompt is a template (prototype) for prompts input to the AI 150, prepared in advance for each agent (role). For example, by applying a message received by the reception unit 11 to the system template, a prompt to be input to the AI 150 is generated.

The control rule is data that define the procedures of input/output (interaction) for the AI 150 and are prepared in advance for each agent (role). To obtain a response appropriate to the execution agent's role for a message entered by a user, it may not suffice to input a prompt to AI 150 just once. For example, it may be necessary to have the AI 150 execute multiple tasks, such as extracting specific information, classification, prediction, or loop processing. In this case, prompts must be input for each task. However, information regarding what prompt should be input to the AI 150 and in what order (i.e., the procedure for interacting with AI 150) is required. That information itself is the defined data, which is the control rule. Interaction with the AI 150 based on a single control rule is hereinafter referred to as a “control procedure.” Within a control procedure, a single prompt input to the AI 150 is called a “phase.” If the control procedure contains multiple phases, multiple system prompts corresponding to each phase are prepared. In this case, the system prompt for a certain phase may be matched with a message received by the reception unit 11.

For system prompts in other phases, responses from the AI 150 obtained during the control procedure up to that phase may be applied. When distinguishing between responses obtained from the AI 150 during the control procedure and the final response obtained from the AI 150 at the end of the control procedure (i.e., the response to the user's message), the former is called an “intermediate response” and the latter is called a “final response.” Furthermore, when only one prompt input is required during the control procedure, the control rule contains one phase and there is only one system prompt. In this case, there is no intermediate response, and the final response is obtained for the single prompt input.

The setting unit 13 performs settings on the AI control unit 16 and the search unit 15 to instruct them to execute behaviors corresponding to the role of the execution agent, based on the agent information of the execution agent input from the agent control unit 12. Switching the execution agent is achieved by switching the settings for the AI control unit 16 and the search unit 15. Switching the settings for the AI control unit 16 per agent is because the system prompts and control rules differ per agent. That is, the system prompts and control rules contained within the agent information of the execution agent are configured for the AI control unit 16. On the other hand, switching the settings for the search unit 15 per agent is necessary because the data storage unit 122 serving as the search target (source for acquiring document data) may differ per agent. For example, agent a3 concerning legal knowledge targets the data storage unit 122 storing legal document data for searching, while agent a4 concerning accounting knowledge targets the data storage unit 122 storing accounting document data for searching. For the Search Unit 15, the data source ID contained in the agent information of the execution agent is set.

When the reception unit 11 receives a message, the conversion unit 14 converts text of the message into a vector (hereinafter referred to as a “semantic vector”) that represents the meaning of the message as a multidimensional numerical value. The semantic vector may be generated using a natural language processing model, such as bidirectional encoder representations from transformers (BERT). The semantic vector that is generated by converting the message may be referred to as a “message vector” in the following description.

The search unit 15 searches for document data stored in the data storage unit 122 corresponding to the data source ID set by the setting unit 13. The search unit 15 uses the message vector generated by the conversion unit 14 to extract a subset of document data stored in the data storage unit 122 corresponding to the data source ID set by the setting unit 13. This subset includes document data relatively highly relevant to the message. Specifically, the data storage unit 122 targeted for search (source of document data retrieval) by the search unit 15 changes according to the settings made by the setting unit 13.

Each data storage unit 122 has document data related to various operations of the Company X pre-stored (registered). However, the set of document data stored differs for each data storage unit 122. This is because required document data varies depending on role of the agent.

Therefore, the data storage units 122 may be prepared for each agent. Furthermore, some or all of the data storage units 122 may be used by two or more agents.

The registration of document data to the each data storage unit 122 may be performed in batches, or the user may upload the document data at any desired time. Each data storage unit 122 stores, for each document data registered therein, the document data itself and a semantic vector for each chunk of that document data. The chunk of the document data refers to a portion of the document data obtained by dividing the document data into predetermined units. The unit for dividing the document data may be the number of characters, the number of sentences, or a semantic unit (e.g., a paragraph, etc.), and it is sufficient if the data is pre-divided and stored by unit by divided. Hereinafter, the semantic vector for each chunk is referred to as a “chunk vector”.

The search unit 15 compares the message vector with the chunk vectors for each chunk of the document data in the data storage unit 122 being searched. It identifies the chunk associated with the chunk vector exhibiting the highest similarity for that document data (hereinafter referred to as the “similar chunk”). The search unit 15 compares the similarity among similar chunks for each document data item. It extracts the top M similar chunks. Consequently, essentially M document data items are extracted.

The similarity between vectors may be evaluated using cosine similarity or other metrics. The search unit 15 includes the top M similar chunks, IDs stored in the data storage unit 122 corresponding to these similar chunks (hereinafter referred to as “chunk IDs”), and IDs stored in the data storage unit 122 corresponding to the document data to which the similar chunks belong (hereinafter referred to as “document IDs”) and file names of the document data to which the similar chunks belong (hereinafter referred to as “document names”). Each data storage unit 122 may be a folder, a database, or any other management unit for a collection of document data.

The AI control unit 16 generates the prompt by applying the message received by the reception unit 11 and the set of similar chunks related to the search results from the search unit 15 to the system prompt set by the setting unit 13. Specifically, the AI control unit 16 generates the prompt by expanding the message received by the reception unit 11 with the set of similar chunks related to the search results from the search unit 15. The method of including the set of similar chunks related to the search results in the prompt may be the same as that of a known RAG. The text of each chunk belonging to the set of similar chunks related to the search results may be included in the prompt, or a vector generated based on the chunk vector of the chunk may be included in the prompt. An example of the system prompt is as follows.

### Example of System Prompt

The message from the user is as follows.

### {Message}

Please generate a response to the message using the following documents as reference.

### {Set of Similar Chunks Related to Search Results}

### End of Example of System Prompt

Thus, the system prompt defines sections for inserting the message and for inserting the set of similar chunks related to the search results generated by the search unit 15. In this case, the AI control unit 16 inserts the message received by the reception unit 11 into the {Message} section of the system prompt and inserts the set of similar chunks related to the search results generated by the search unit 15 into the {Set of similar chunks related to the search results} section to generate the prompt. By inputting the prompt generated in this manner to the AI 150, the AI 150 can generate a response utilizing knowledge (knowledge not learned by the AI 150) contained within the set of similar chunks related to the search results. That is, the response from the AI 150 can be based on the set of similar chunks related to the search results. Furthermore, the system prompt may include a string to notify the AI 150 of the agent's role corresponding to the system prompt, such as “You are XXX.” (where XXX is a string indicating the role).

Furthermore, when the control procedure includes multiple phases, a system prompt may be defined for a given phase that explicitly indicates where the intermediate response obtained in a phase preceding that phase (e.g., for the Kth phase, an intermediate response obtained in any phase from the 1st phase to the K-1st phase) is to be applied.

The AI control unit 16 also performs interactions (interactions) with the AI 150 according to the control procedure based on control rules set by the setting unit 13.

The AI control unit 16 also interacts with the AI 150 according to the control procedure based on control rules set by the setting unit 13. For each phase of this control procedure, the AI control unit 16 generates the prompt based on the system prompt corresponding to that phase and sends this prompt to the AI 150. It then receives the response to this prompt from the AI 150.

Furthermore, whenever the final response is obtained from the AI 150, the AI control unit 16 associates the message and search results that led to that final response with the final response itself and stores them in the history information storage unit 123. The intermediate responses may also be stored associated with the final response.

Therefore, the history information storage unit 123 stores history information of the dialogue (input/output of the AI 150) between the user and the agent.

FIG. 5 is an example of the history information storage unit 123. As shown in FIG. 5, the history information storage unit 123 stores history information including a session ID, user ID, response ID, message, and search results for each final response from the AI 150. The session ID is a unique ID for each session. A session refers to a series of exchanges between the user and the agent, including messages and final responses (intermediate responses may also be included), occurring from the time the interactive screen 510 is displayed until it is closed. The same session ID is assigned to final responses output within the same session. The date in history information storage unit 123 may be stored in a table or database format, as shown in FIG. 5.

The user ID is identification information for the user who conducted the session (dialogue) associated with the session ID. The user ID may be identified by performing user authentication. The response ID is, for example, a unique ID for each final response, assigned when the AI control unit 16 records the final response in the history information storage unit 123. Messages and search results stored in the history information storage unit 123 are applied to the prompt that led to the final response.

The display control unit 17 displays the agent, who is the dialogue partner with the user, in an identifiable manner. The display control unit 17 further displays information (hereinafter referred to as “final response information”) received by the AI control unit 16, including the final response, on the terminal 20 that sent the message. The display control unit 17 specifically transmits display content to the terminal 20 for displaying the terminal 20's screen. The terminal 20 displays the screen based on the display content using a browser. The final response information includes not only the final response but also information indicating the document data to which each similar chunk pertaining to the search results from the search unit 15 belongs. Therefore, the user can confirm what document data the final response was generated based on.

The display control unit 17 also displays information on the terminal 20 that allows the user to recognize that the dialogue partner has been switched when the execution agent changes.

The terminal 20 has a reception unit 21, a communication unit 22, and a display control unit 23. Each of these units is realized by processing executed by a CPU of the terminal 20 via a program installed on the terminal 20. The reception unit 21 receives user operations directed at the terminal 20. The communication unit 22 controls communication with the information processing apparatus 10. The display control unit 23 controls the display of screens (e.g., the interactive screen 510 described later) based on information (display data) received from the information processing apparatus 10.

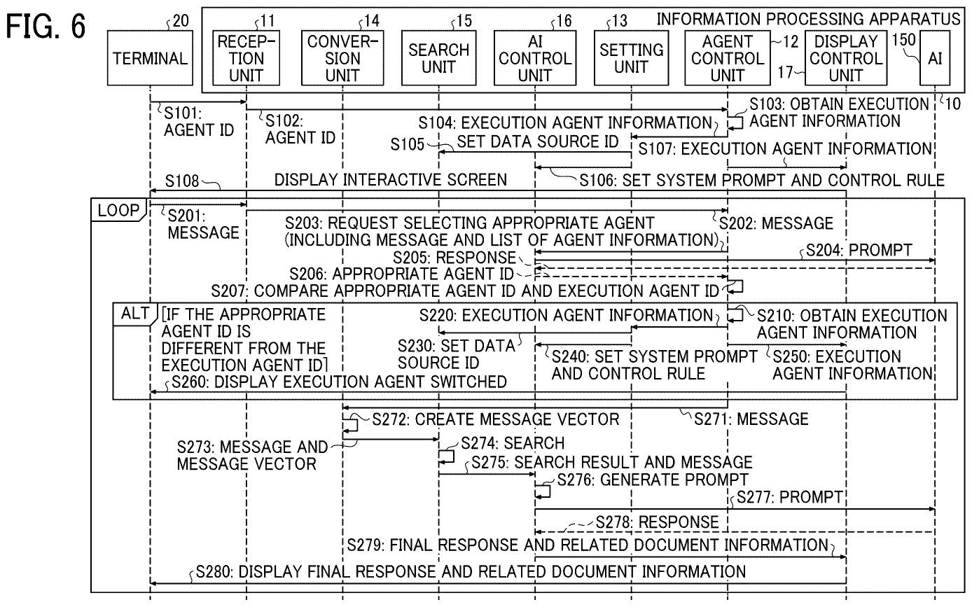

The following describes the processing steps executed by the information processing system. FIG. 6 is a sequence diagram illustrating an example of a processing procedure executed by the information processing system in the first implementation. At the start of the processing procedure in FIG. 6, it is assumed that the user is already logged in to the information processing apparatus 10 (authenticated by the information processing apparatus 10) and that the execution agent selection screen is displayed on the terminal 20. The execution agent selection screen displays a list of selectable agents. At this time, the list may include agents sorted based on their roles (e.g., in alphabetical order of strings indicating the role). Furthermore, some agents within the list may be searchable. In this case, the execution agent selection screen allows input of a search keyword, and agents with relatively high role similarity to that keyword may be displayed on the execution agent selection screen.

When the user selects any agent displayed on the execution agent selection screen, the terminal 20 transmits the identification information (hereinafter referred to as “agent ID”) of the selected agent to the information processing apparatus 10 (S101). In response to receiving the agent ID, the reception unit 11 of the information processing apparatus 10 inputs the agent ID to the agent control unit 12 (S102).

The agent control unit 12 obtains the agent information corresponding to the input agent ID from the agent information storage unit 121 (S103). Hereinafter, the agent information acquired in step S103 of FIG. 6 is referred to as “execution agent information”. Subsequently, the agent control unit 12 inputs the execution agent information to the setting unit 13 (S104).

The setting unit 13 sets the data source ID of the input execution agent information to the search unit 15 (S105) and sets the control rules and the system prompts for the execution agent information to the AI control unit 16 (S106). As a result, the search unit 15 searches the data storage unit 122 corresponding to the execution agent, and the AI control unit 16 executes the control procedure corresponding to the execution agent.

The agent control unit 12 also notifies the display control unit 17 of the execution agent information (S107). The display control unit 17 displays an interactive screen on the terminal 20 where the user's interaction partner is the agent (execution agent) associated with the execution agent information (S108). Specifically, the display control unit 17 generates display data for the interactive screen and transmits this display data to the terminal 20 to display the interactive screen.

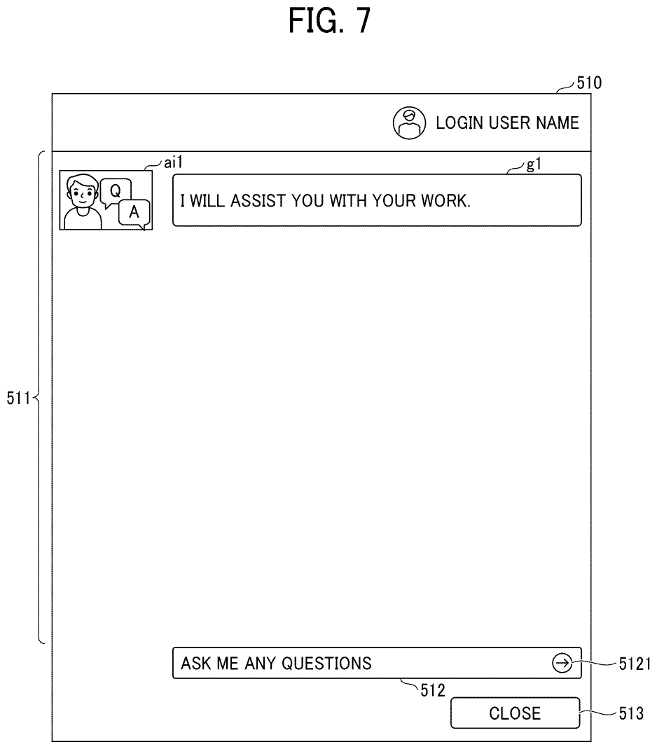

FIG. 7 is a diagram showing an example of the interactive screen display at the start of a dialogue. The interactive screen 510 shown in FIG. 7 includes a dialogue display area 511, a message input area 512, and a button 513. The dialog display area 511 is the area where the content of the dialog between the execution agent and the user is displayed. In the initial state, the dialog display area 511 displays a greeting message g1 (“I will assist you with your work.”) prompting the user to input a message. To the left of the greeting message g1, the execution agent icon ai1 is displayed. Icon ai1 is an image stored in the file corresponding to the icon name in the execution agent information. The user can visually recognize the agent currently interacting with them (i.e., the execution agent) through icon ai1. The message input area 512 is an area for receiving message input from the user
and includes a send icon 5121. Button 513 is a button for receiving instructions to end the dialogue from the user.

When the user inputs a message into the message input area and clicks the send icon 5121, the terminal 20 sends that message (hereinafter referred to as the “target message”) to the information processing apparatus 10 (S201).

In response to receiving the target message, the reception unit 11 inputs the target message to the agent control unit 12 (S202). The agent control unit 12 inputs an agent selection request to the AI control unit 16. This request includes the target message and a list of all agent information stored in the agent information storage unit 121 (S203). This selection request signifies a request to select one agent (hereinafter referred to as the “appropriate agent”) which is appropriate to generate a response to the target message. Being appropriate for generating a response means being capable of outputting the most appropriate response.

The AI control unit 16 generates the prompt for instructing the AI 150 to select the appropriate agent, based on the target message, the list of agent information, and the system prompt prepared in advance for selecting the appropriate agent. It then sends this prompt to the AI 150 (S204). The prompt generated at this time is one that requests the selection of one agent with the appropriate role to generate a suitable response to the user's message from among multiple agents with different roles. In other words, this is a prompt that causes the AI to determine the type of response the user is seeking based on the message input by the user, and then causes the AI to determine which agent can provide that type of response based on each agent's role.

A simple example of this system prompt is as follows.

### Example of System Prompt Starts Here

The message from the user is as follows.

### {Message}

The candidate agents capable of responding to the above message are as follows.

### {List of Agent IDs and Agent Descriptions}

From the above agents, select the agent that can output the most appropriate response to the above message and output that agent's Agent ID.

### End of System Prompt Example

In this case, the AI control unit 16 generates the prompt by substituting the target message into the {Message} section of the system prompt and substituting the agent ID and description (i.e., the agent's role) for each agent into the {List of agent IDs and agent descriptions} section.

The AI 150, having input the prompt generated as described above, selects the most appropriate agent from among the agents listed within that prompt based on its learned parameters. The AI 150, having received the prompt generated as described above, selects an appropriate agent from among those listed in the prompt based on its learned parameters. It then generates a response containing the ID of the selected agent. The AI 150 sends this response to the AI control unit 16.

Next, the AI control unit 16 receives the response from the AI 150 (S205). This response includes the agent ID of the agent selected as the appropriate agent. Subsequently, the AI control unit 16 outputs this agent ID (hereinafter referred to as the “appropriate agent ID”) to the agent control unit 12 (S206).

The agent control unit 12 compares the appropriate agent ID output by the AI control unit 16 with the agent ID of the execution agent information acquired in step S103 (hereinafter referred to as the “execution agent ID”). It then determines whether an agent (second agent) exists that can output a more suitable response to the target message than the execution agent (S207). This second agent is an alternative agent of execution agent. This process (S207) is also said to determine a second interactive AI, which output an appropriate response (alternative response) to the message better than the response of the first interactive AI, as explained below.

If a value of the appropriate agent ID and a value of the execution agent ID are different, the agent control unit 12 determines that an agent (second agent) capable of outputting a more appropriate response to the target message than the execution agent exists. In this case, steps S210 to S260 are executed, and the execution agent is changed. If the value of the appropriate agent ID and the value of the execution agent ID are the same, the agent control unit 12 determines that no agent exists that can output a more appropriate response to the target message than the execution agent. In this case, steps S210 to S260 are not executed, and step S271 and subsequent steps are executed.

First, the case where the appropriate agent ID and the execution agent ID are the same is described. Then in step S271, the agent control unit 12 inputs the target message to the conversion unit 14.

The conversion unit 14 generates a message vector by converting the input target message into the message vector (S272). Next, the conversion unit 14 inputs the message vector (hereinafter referred to as the “target message vector”) and the target message to the search unit 15 (S273).

The search unit 15 identifies similar chunks for each document data by comparing the input target message vector with the chunk vectors, wherein the chunk vector stored in the data storage unit 122 for each document data and for each document. At the timeB the data storage unit 122 associated with the data source ID set by the setting unit 13 (i.e., the data corresponding to the execution agent). The search unit 15 extracts a subset of the similar chunks with relatively high similarity to the target message (S274). For example, the top X similar chunks based on similarity between the target message vector and the chunk vectors are extracted. The search unit 15 then generates a search result for each extracted similar chunk containing the related document information for that chunk. Subsequently, the search unit 15 transmits the search result and the target message to the AI control unit 16 (S275).

The AI control unit 16 generates the prompt based on the input search result, target message, the control rules and the system prompts, that the control rules and system prompts set by the setting unit 13 to generate a prompt (S276). Subsequently, the AI control unit 16 sends the prompt to the AI 150 (S277). The AI control unit 16 then receives the response from the AI 150, that the response generated by the AI 150 (S278). Note that depending on the control procedure, the first response may not be the final response, and the final response is obtained by repeating steps S276 to S278 multiple times.

When the final response is obtained, the AI control unit 16 records the final response in the history information storage unit 123, associating it with the target message and the corresponding search result. Subsequently, the AI control unit 16 inputs the final response (hereinafter referred to as the “target final response”) and the final response information, which includes the related document information from the search results, to the display control unit 17 (S279).

The display control unit 17 displays the input final response information (the target final response and the related document information) on the interactive screen 510 displayed on the terminal 20 (S280). Specifically, the display control unit 17 generates display data for the final response information and transmits the generated display data to the terminal 20 to display the final response information on the interactive screen 510 displayed on the terminal 20.

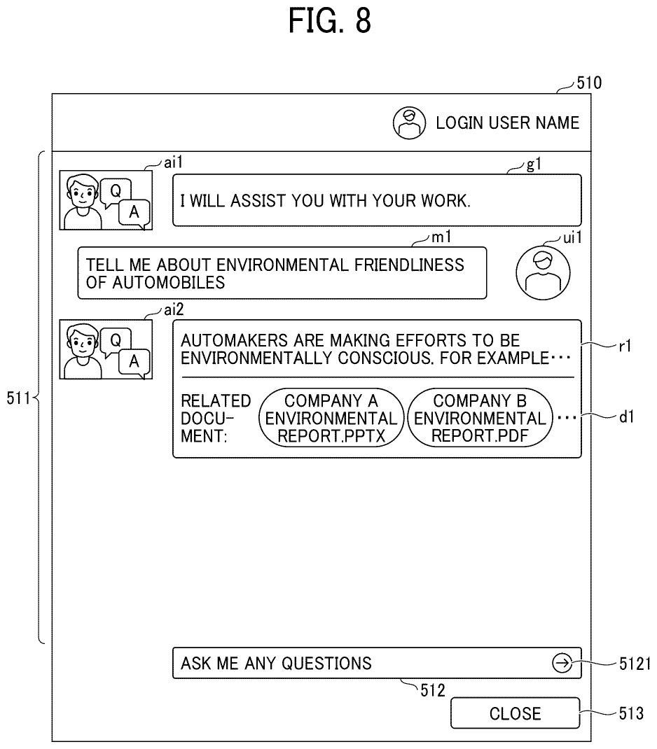

FIG. 8 is a diagram showing an example of displaying the final response information. In FIG. 8, identical parts to those in FIG. 7 are marked with the same reference numerals, and their descriptions are omitted. In the interactive screen 510 shown in FIG. 8, the message m1, response r1, and related document information d1 have been added. The message m1 is the target message input by the user into the message input area 512 in step S201. When the user clicks the send icon 5121, the target message entered in the message input area 512 is displayed in the dialog display area 511.

The response r1 is the target final response and is a response to a message from the execution agent. The related document information d1 is the related document information for the target final response. Therefore, the information including response r1 and related document information d1 constitutes the final response information for message m1.

FIG. 8 shows an example where a list of document names included in the related document information is displayed as the related document information d1. The target final response may be split across multiple speech bubbles. FIG. 8 also shows that icon ui1 is added to the right of the message m1, and icon ai2 is added to the left of the response r1. Icon ui1 is the user's icon, and Icon ai2 is the icon of the execution agent that provided the final response. Here, since the execution agent has not switched, icon ai2 is the same as icon ai1.

The user may continue the dialogue as is or end the dialogue. To end the dialogue, the user clicks button 513. In this case, the session ends, and the procedure of FIG. 6 is completed. If the user continues the dialogue, they input a new message in the message input area 512 and click the send icon 5121. In this case, the process starting from step S201 is repeated with this message as the target message. That is, the process starting from step S201 is repeatedly executed until button 513 is clicked.

During the execution of steps S201 and subsequent steps, we describe the case where the value of the appropriate agent ID differs from the value of the execution agent ID. Specifically, this occurs when it is determined that the one agent exists that can output a more appropriate response to the target message than the execution agent. In this case, steps S210 to S260 are executed.

In step S210, the agent control unit 12 obtains the agent information corresponding to the appropriate agent ID as the execution agent information from the agent information storage unit 121 (FIG. 4). In steps S220 to S250, processing similar to and corresponding to steps S104 to S107 are executed and therefore the description thereof is not repeated.

Upon notification of the new execution agent information in step S250, the display control unit 17 causes the currently displayed interactive screen 510 to display information identifying that the execution agent has been switched (S260). Specifically, the display control unit 17 generates display data to display information identifying that the execution agent has been switched and transmits this display data to the terminal 20.

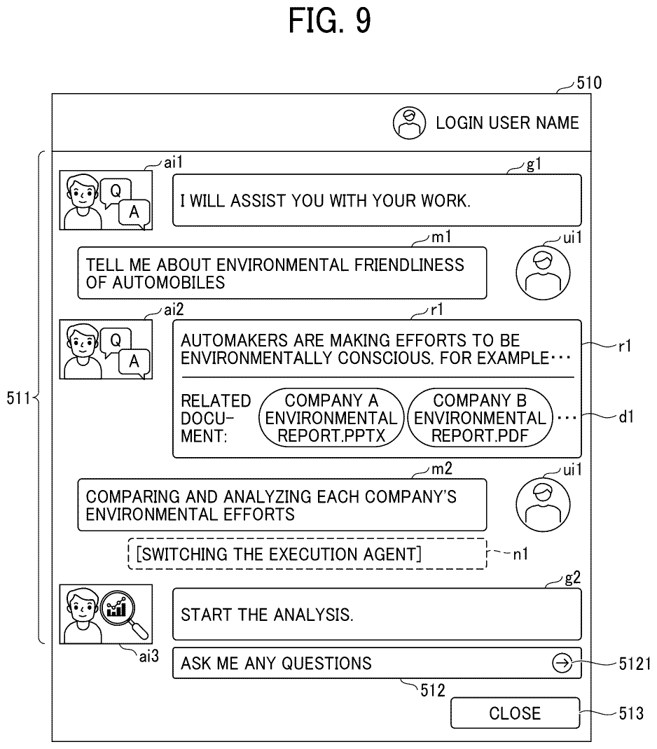

FIG. 9 is a diagram showing an example display of the interactive screen indicating the switching of the execution agent. In FIG. 9, identical parts to those in FIG. 8 are labeled with the same reference numerals, and their descriptions are omitted. In the interactive screen 510 shown in FIG. 9, message m2, notification text n1, and greeting text g2 have been added. Message m2 is the new target message. That is, FIG. 9 shows an example display in which the appropriate agent for message m2 is not the first or original execution agent.

The notification text n1 and the greeting text g2 are display information added in step S260 to notify the user of the execution agent switch. The notification text n1 is a string indicating the execution agent switch. The greeting text g2 is a greeting from the new execution agent.

Furthermore, the icon ai3 to the left of the greeting text g2 differs from the icons ai1 and ai2 of the previous execution agents. This is because the icon ai3 corresponds to the icon name included in the agent information of the new execution agent. Thus, the change in icon also enables the user to identify the switch of the execution agent.

Following step S260 in FIG. 6, steps S271 and subsequent steps are executed. In this case, the search unit 15 searches for document data from the data storage unit 122 corresponding to the data source ID set in step S230 (S274). Furthermore, the AI control unit 16 executes steps S276 to S278 based on the control rules and system prompts set in step S240 to obtain the final response.

As a result, the response based on the document data different from that of the execution agent before the switch, and a response based on a system prompt (query method) different from that of the execution agent before the switch, can be obtained as the final response. That is, the final response corresponding to the execution agent after the switch is obtained. Therefore, the possibility of outputting a more appropriate response to a message from the user increases.

As described above, according to the first implementation, among multiple types of the agents each having different roles, it is determined whether the one agent (second agent) exists that can output a more appropriate response than the execution agent (first agent) to the message from the user. If such an agent exists, the execution agent is switched to the second agent. Consequently, switching to the agent capable of outputting the more appropriate response to the user's message becomes possible. As a result, the quality of responses to user messages can be improved.

Next, the second implementation is described. The second implementation describes the points differing from the first implementation. Therefore, points not specifically mentioned are the same as in the first implementation. In the first implementation, the execution agent was forcibly switched when it was not the appropriate agent. The second implementation describes an example where the user selects whether to switch the execution agent.

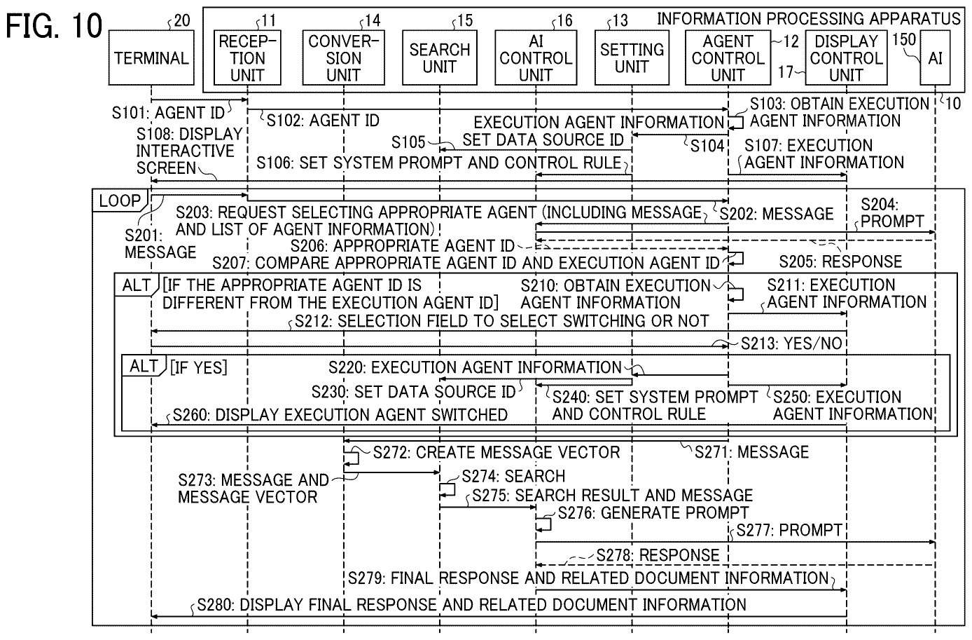

FIG. 10 is a sequence diagram illustrating an example of a processing procedure executed by the information processing system in the second implementation. In FIG. 10, the same step numbers are assigned to steps identical to those in FIG. 6, and their descriptions are omitted. In FIG. 10, steps S211 to S213 are added between steps S210 and S220 as compared to FIG. 6.

In step S211, the agent control unit 12 notifies the display control unit 17 of the execution agent information obtained in step S210. Based on the notified execution agent information (information about the target execution agent to switch to), the display control unit 17 displays a screen on the terminal 20 that prompts the user to select whether to switch the execution agent.

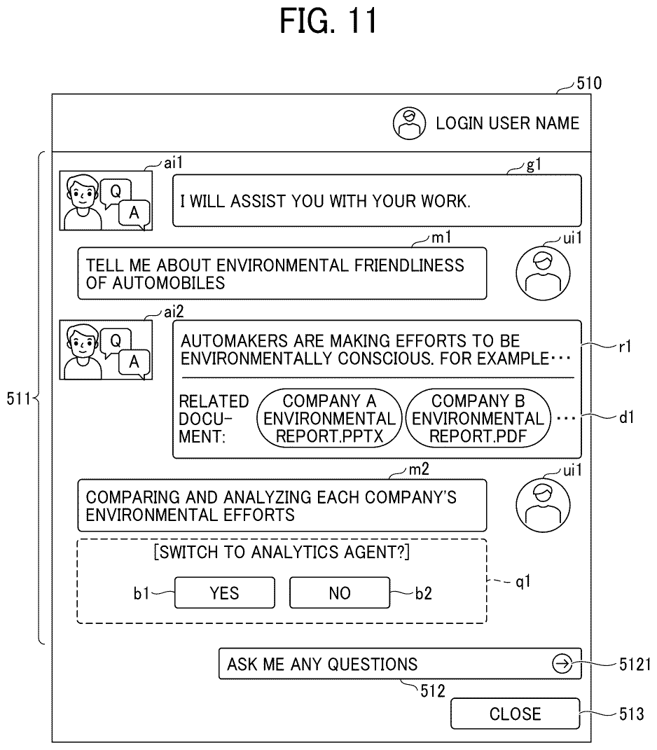

FIG. 11 is an example of the display of an interactive screen prompting the user to select whether to switch the execution agent. In FIG. 11, identical parts to those in FIG. 9 are labeled with the same reference numerals, and their descriptions are omitted.

In FIG. 11, a selection area q1 is displayed for message m2. Selection area q1 is an area for allowing the user to select whether to switch the execution agent. In FIG. 11, q1 includes text strings indicating whether to switch to the analysis agent, and buttons b1 and b2. The YES button b1 is a button for accepting the selection to switch. The NO button b2 is a button for accepting the selection to not switch.

When the user clicks the button b1 or the button b2, the terminal 20 sends information corresponding to the clicked button to the information processing apparatus 10 (FIG. 10, S213). Specifically, the terminal 20 sends information indicating “YES” when the button b1 is clicked and sends information indicating “NO” when the button b2 is clicked. Upon receiving this information, the agent control unit 12 branches processing based on the information.

If the information indicates “YES”, the agent control unit 12 executes steps S220 to S260. In this case, the display control unit 17, in step S260, displays information (such as the notification text n1, greeting text g2, and icon ai3 in FIG. 9) on the interactive screen 510 of FIG. 1 that makes it identifiable that the execution agent has been switched. This information may be displayed below the selection area q1 or after hiding the selection area q1. Subsequently, the response is performed by the switched execution agent.

On the other hand, if the information indicates “NO”, the agent control unit 12 executes step S271. In this case, the execution agent is not switched, and the response to the message is performed.

As described above, according to the second implementation, when the agent (the second agent) capable of outputting a more appropriate response than the execution agent (the first agent) exists for the message from the user to the execution agent, the screen (FIG. 11) is displayed to allow the user to select whether to switch the execution agent. Therefore, the user's intent regarding switching the execution agent can be reflected.

In the above implementations, step S260 (FIG. 6, FIG. 10) causes a display of the notification text n1, the greeting text g2, and the icon ai3 from FIG. 9 as examples of information identifying that the execution agent has been switched. However, this information may be realized by other means.

For example, in step S260, the display control unit 17 may display the agent name of the execution agent in addition to or instead of icon ai3. Alternatively, in step S260, the display control unit 17 may display a new interactive screen 510 on terminal 20, separate from the currently displayed interactive screen 510, for interacting with the switched execution agent. As long as the switching of the execution agent is identifiable to the user, the display may be performed in other forms.

Furthermore, in the above implementations, the identification of an appropriate agent is shown as being implemented by the procedure shown in steps S202 to S206 (FIG. 6, FIG. 10), but the appropriate agent may also be identified by other procedures.

For example, after identifying the appropriate agent, if the appropriate agent differs from the current execution agent in step S207, it may be determined whether switching the current execution agent is necessary. In this case, following step S207, the agent control unit 12 inputs the target message and the agent information (execution agent information) of the current execution agent to the AI control unit 16.

The AI control unit 16 generates the prompt that inquires whether switching the execution agent is necessary, using the target message and the description of the execution agent information. For example, the prompt with content such as “The execution agent performs the role indicated in the description, but is it appropriate for responding to the target message?” may be generated. The AI control unit 16 sends this prompt to the AI 150 and receives a response from the AI 150.

The AI control unit 16 outputs this response to the agent control unit 12. If the response indicates that the execution agent is appropriate, the agent control unit 12 executes step S271 without switching the execution agent. If the response indicates that the execution agent is not appropriate, the agent control unit 12 executes step S210 to switch the execution agent.

Alternatively, after determining whether the execution agent is appropriate, the identification of an appropriate agent may occur only if the execution agent is not appropriate. The procedure for determining the execution agent's appropriability and the procedure for identifying the appropriate agent are as described above.

Thus, by preparing the control rules for each agent in advance, the agent can be controlled by those rules. This enables switching the dialogue partner to another agent which provides an appropriate response to the message, based on the explanatory text describing the agent's role and capabilities as defined by the control rules, and the message input by the user.

Next, the third implementation is described. The third implementation explains the points differing from the above implementations (or points not explicitly described). Therefore, points not specifically mentioned may be considered the same as in the above implementations. The third implementation describes an example where the terminal 20 displays various screens via a web browser, and the information processing apparatus 10 functions as a web server executing web applications.

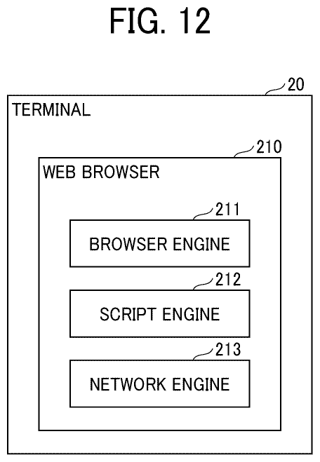

FIG. 12 is a diagram showing an example of the functional configuration of the terminal 20 in the third implementation. In FIG. 12, the terminal 20 has a web browser 210. The web browser 210 is a general web browser and includes a browser engine 211, a script engine 212, and a network engine 213. The browser engine 211 interprets HTML (Hyper Text Markup Language) data and CSS (Cascading Style Sheets) data that constitute a web page and displays the web page. The script engine 212 executes scripts (e.g., JavaScript®) that constitute the web page. The network engine 213 sends HTTP requests and receives HTTP responses.

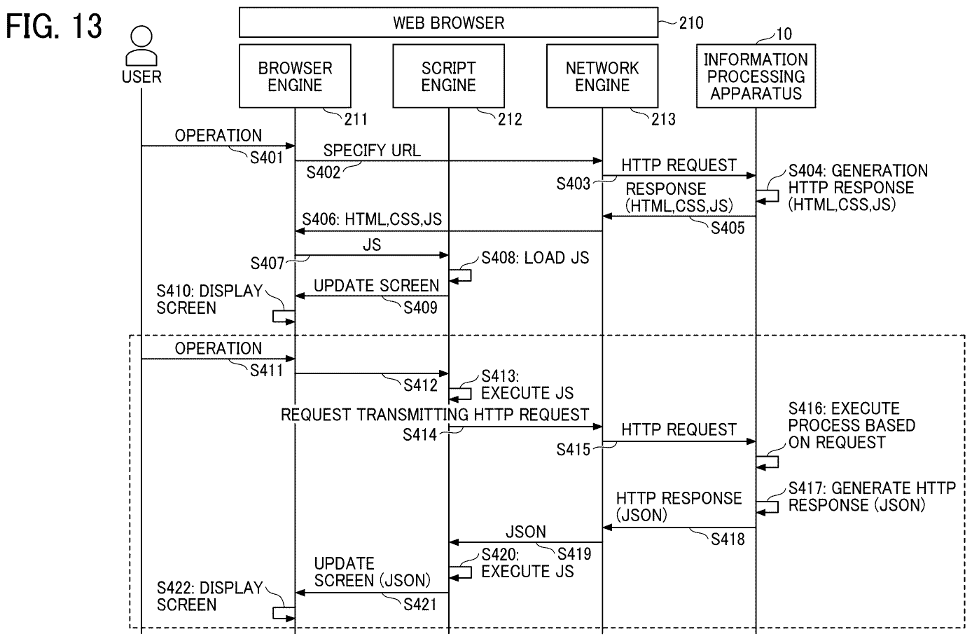

FIG. 13 is a sequence diagram illustrating an example processing procedure for screen transitions in the third implementation. At the start of FIG. 13, the Web browser 210 on the terminal 20 is assumed to be displaying the execution agent selection screen.

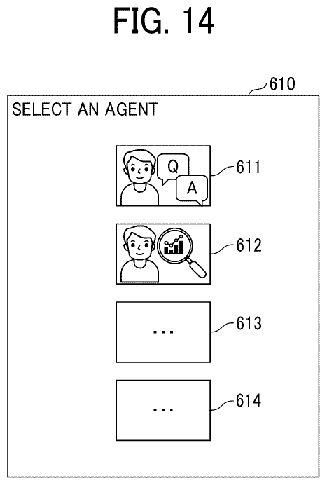

FIG. 14 is a diagram showing an example display of the execution agent selection screen. As shown in FIG. 14, the execution agent selection screen 610 displays icons 611 to 614 for each selectable agent.

When the user selects one of the icons on the execution agent selection screen 610 (S401), the browser engine 211 inputs a URL into the network engine 213 (S402). This URL contains, as optional information, either the agent ID of the agent corresponding to the selected icon or information identifying the selected icon, and serves as the destination for an HTTP request to the information processing apparatus 10. The network engine 213 sends an HTTP request to the URL (S403).

In response to this HTTP request, the display control unit 17 of the information processing apparatus 10 generates an HTTP response containing web content data (HTML data, SS data, and script (hereinafter referred to as “JS”) corresponding to the URL targeted by the HTTP request (S403). This web content is used to generate multiple web pages displayed subsequently. Furthermore, JS includes multiple JS that execute processing corresponding to operations for each screen.

Next, the display control unit 17 transmits the HTTP response generated in step S404 to the terminal 20 (S405). When the network engine 213 of the terminal 20 receives the HTTP response, it inputs the HTML data, the CSS data, and the JS contained in the HTTP response to the browser engine 212 (S406). The browser engine 212 inputs the JS input from the network engine 213 to the script engine 212 (S407). The script engine 212 loads the JS (S408) and requests the browser engine 211 to update the screen (S409). The screen update includes displaying a new screen.

The HTTP response generated in step S404 may contain the JS filename rather than the JS entity itself. In this case, in step S408, the script engine 212 accesses an external file based on the filename and downloads the JS. This method involves loading the JS as the external file.

Subsequently, the browser engine 211 displays the interactive screen 510 based on the HTML data and the CSS data (S410). For example, if the icon 611 is selected on the execution agent selection screen 610, the interactive screen 510 shown in FIG. 7 is displayed.

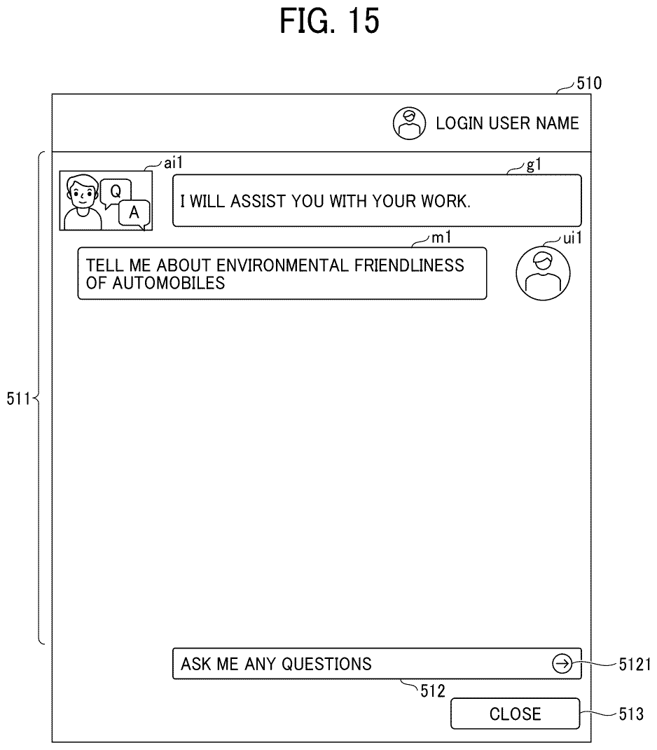

When the user inputs the message into the message input area 512 of the interactive screen 510 (FIG. 7) and clicks the send icon 5121 (S411), the display content of the interactive screen 510 changes as shown in FIG. 15.

In FIG. 15, the message entered at the message input area 512 in FIG. 7 is displayed as the message m1 in the interactive display area 511. Next, the browser engine 211 executes inputting of the message and notifies the script engine 212 of both the message input and the message itself (S412).

In response to the notification from the browser engine 211, the script engine 212 executes one of the multiple JS (S413). This JS performs the processing to send the input message to the information processing apparatus 10. By executing this JS, the script engine 212 send a request to send the HTTP request corresponding to the input message and the message to the network engine 213 (S414). The network engine 213 sends the HTTP request containing the message to the information processing apparatus 10 (S415).

When the reception unit 11 of the information processing apparatus 10 receives the HTTP request, the information processing apparatus 10 executes the processing requested by the HTTP request (S416). For the HTTP requests corresponding to the message input on the interactive screen 510 shown in FIG. 7, steps S202 to S279 of FIG. 6 are executed. As a result, the final response to the input message and the related document information are obtained as the processing result. Note that steps S210 to S260 (switching the execution agents) of FIG. 6 are not executed here.

Next, the display control unit 17 generates the HTTP response containing JSON (Java Script Object Notation) describing the final response and the related document information as the processing result (S417). Subsequently, the display control unit 17 transmits this HTTP response to the terminal 20 (S418).

Upon receiving this HTTP response, the network engine 213 of the terminal 20 inputs the JSON contained within the HTTP response to the script engine 212 (S419). The script engine 212 executes one of the multiple JS, specifically the JS that updates the displayed content of the web page based on the JSON (S420). The script engine 212 requests the browser engine 211 to update the displayed content of the web page based on the JSON (S421).

The browser engine 211 updates the display content of the interactive screen 510 from the state shown in FIG. 15 to the state shown in FIG. 8 (S422) based on the HTML data and the CSS data acquired in step S406 and the JSON.

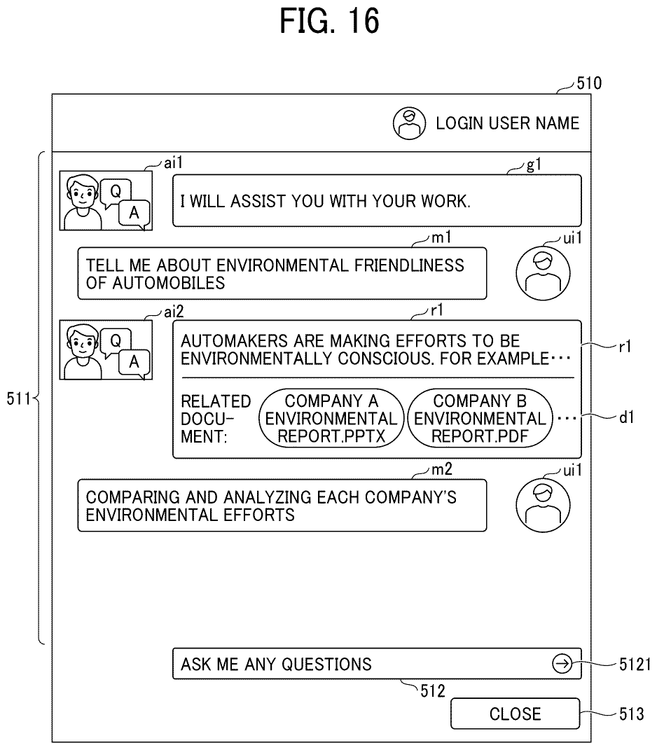

Thereafter, steps S411 to S422 are repeated in response to user operations on the interactive screen 510. However, the data processed in each step differs. For example, when the user enters the message into the message input area 512 of the interactive screen 510 (FIG. 8) and clicks the send icon 5121 (S411), the displayed content of the interactive screen 510 changes as shown in FIG. 16.

In FIG. 16, the message m2 entered the message input area 512 of FIG. 8 is displayed in the message input area 511. Subsequently, the browser engine 211 executes the input of the message and notifies the script engine 212 of the message (S412).

In response to the notification from the browser engine 211, the script engine 212 executes one of the multiple JS (S413). This JS performs the processing to send the input message to the information processing apparatus 10. Consequently, a request to send the HTTP request corresponding to the input message and the message are input to the network engine 213 (S414). The network engine 213 transmits the HTTP request containing the message to the information processing apparatus 10 (S415).

When the reception unit 11 of the information processing apparatus 10 receives the HTTP request, the information processing apparatus 10 executes the processing requested by the HTTP request (S416). For HTTP requests corresponding to message input on the interactive screen 510 of FIG. 16, steps S202 to S207 and S210 to S250 of FIG. 6 are executed. Subsequently, steps S271 to S279 are executed. As a result, the execution agent information for the appropriate agent that is a switched destination, the final response to the input message, and the related document information are obtained as the processing result.

Next, the display control unit 17 generates the HTTP response containing the information (the notification n1 in FIG. 9) identifying that the execution agent has been switched, along with the final response and the related document information as processing results, described in JSON (S417). Subsequently, the display control unit 17 transmits this HTTP response to the terminal 20 (S418). This HTTP response corresponds to steps S260 and S280 in FIG. 6.

FIG. 6 describes an example where the information identifying that the execution agent has been switched (the notification n1 in FIG. 9) and the final response and the related document information are sent separately. Here, an example is shown where they are described in a single JSON and sent to the terminal 20.

After receiving the HTTP response, the network engine 213 of the terminal 20 inputs the JSON contained within the HTTP response to the script engine 212 (S419). The script engine 212 executes one of the multiple JS, specifically the JS that updates the displayed content of the web page based on the JSON (S420), thereby requesting the browser engine 211 to update the displayed content of the web page based on that JSON (S421). The browser engine 211 updates the display content of the interactive screen 510 from the state shown in FIG. 16 to the state shown in FIG. 9 (S422) based on the HTML data and the CSS data acquired in step S406 and the JSON.

The above described is an example where the interactive screen 510 shown in FIG. 7 is displayed in step S410. However, the screen displayed in step S410 may also be the execution agent selection screen 610. That is, the HTTP request (S405) when displaying the execution agent selection screen 610 may include web content (HTML data, CSS data, and JS) for displaying multiple web pages displayed after the interactive screen 510 shown in FIG. 7.

As described above, in the third implementation, the web content data, including the script, is transmitted to the terminal 20. The web contents data is used to display the first web page (e.g., the interactive screen 510 in FIG. 7) identifiably displays the first interactive AI, and the second web page (e.g., the interactive screen 510 in FIG. 9) identifiably displays that the interactive partner has been switched to the second interactive AI.

The web content data, including the script that execute processing to transmit the message input on the first web page to the information processing apparatus 10 and processing to display the second web page identifiably displays the second interactive AI.

Furthermore, when the HTTP request transmitted by execution of the script on the terminal 20 is received by the reception unit 11, the HTTP request includes the message entered on the first web page displayed on the terminal 20 based on the web content data.

Upon receiving the HTTP request, the agent control unit 12, functioning as a judgment unit, determines whether a second interactive AI exists among plurality of agents that can output a more appropriate response to the message than the first interactive AI. If the agent control unit 12, acting as a switching unit, determines that the second interactive AI exists, it switches the interactive partner to the second interactive AI.

Furthermore, the display control unit 17, in order to display the second web page by having the terminal 20 execute the script, includes information indicating that the interactive partner has been switched in the HTTP response, which is the response to the HTTP request, and sends it to the terminal 20. In this way, the web content data including the JS is transmitted to the terminal 20 at one time in step S405.

The JS includes JS scripts for executing a process according to an operation on the first web page, displaying a web page (for example, the second web page) after screen transition resulted from the process, and executing a process according to another operation on each web page displayed after screen transition. Since each screen transition is executed by the JS, the terminal 20 does not need to download the web content data after the screen transition again. Accordingly, the display speed of, for example, the second screen is increased and the communication load in the screen transition is reduced.

Although the main functions of the information processing system 1 are implemented by the information processing apparatus 10 in the above implementations, the terminal 20 may execute the functions of the information processing apparatus 10.

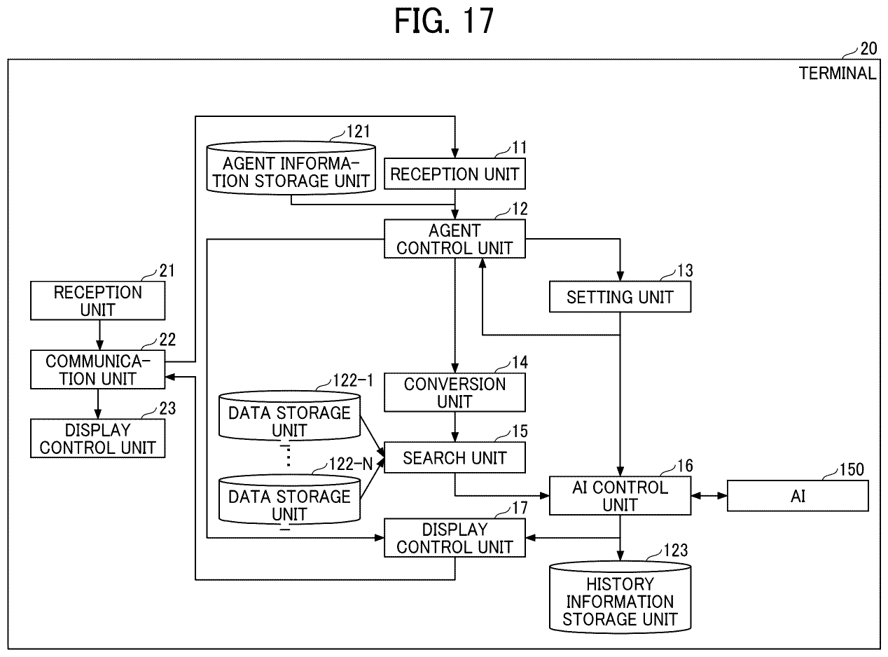

FIG. 17 is a diagram showing an example of the functional configuration of the terminal 20 that incorporates the functions of the information processing apparatus 10. In FIG. 17, the same reference numerals are used for the same parts as in FIG. 3, and their descriptions are omitted. Each functional configuration in FIG. 17, as described above, has functions similar to the functional configuration in FIG. 3 and executes processing similar to the sequence diagrams in FIGS. 6 and 10.

In FIG. 17, the functions of the information processing apparatus 10 in the above implementations are implemented by processes that one or more programs installed in the terminal 20 cause the CPU of the terminal 20 to execute.

One of the information processing apparatus 10 and the terminal 20 may not have all of the functions illustrated in FIG. 3 (or FIG. 17), and each of the information processing apparatus 10 and the terminal 20 may have some of the functions. In a case where each of the information processing apparatus 10 and the terminal 20 has some functions, the classification of the function group of the information processing apparatus 10 and the function group of the terminal 20 is not limited to a specific form. For example, the processing S20-S240 for identifying the appropriate agent may be performed by the group of functions possessed by the terminal 20, and the processing S271-S280 for creating the final response may be performed by the group of functions possessed by the information processing apparatus 10.

The network engine 213 is an example of a terminal's receiving unit and transmitting unit. The browser engine 211 is an example of a second display control unit. The script engine 212 is an example of an execution unit.

The information processing apparatus 10 may be any apparatus having a communication function, which may be implemented by communication circuitry. The information processing apparatus 10 may be, for example, an output device such as a projector (PJ), an interactive whiteboard (IWB; an electronic whiteboard having a blackboard function enabling mutual communication), or digital signage, or may be a head-up display (HUD), an industrial machine, an imaging device, a sound collecting device, a medical device, a networked home appliance, a laptop personal computer (PC), a mobile phone, a smartphone, a tablet terminal, a game console, a personal digital assistant (PDA), a digital camera, a wearable PC, or a desktop PC.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a recording medium such as a compact disc-read-only memory (CD-ROM) or DVD, and/or the memory of an FPGA or ASIC.

The apparatuses or devices in the above implementations are only illustrative of one of several computing environments for implementing the one or more implementations disclosed herein. In some implementations, the information processing apparatus 10 includes multiple computing devices, such as a server cluster.

The multiple computing devices are configured to communicate with one another via any type of communication link, including networks or shared memory, and perform the processing disclosed herein. The terminal 20 may also include multiple computing devices configured to communicate with one another.

The above-described implementations are illustrative and do not limit the present disclosure. Thus, numerous additional modifications and variations are possible in light of the above teachings. For example, elements and/or features of different illustrative implementations may be combined with each other and/or substituted for each other within the scope of the present disclosure.

Any one of the above-described operations may be performed in various other ways, for example, in an order different from the one described above. Although the implementations of the present invention have been described in detail above, the disclosure is not limited to these specific implementations. Various modifications and changes are possible within the scope of the essence of the disclosure as described in the appended claims.

The following non-limiting examples illustrate aspects of the present disclosure.

According to a first aspect, an information processing system includes a display control unit, a reception unit, a determination unit, and a switching unit. The display control unit displays a first conversational AI that is an interlocutor for a user. The reception unit accepts message input directed at the conversational AI. The determination unit determines whether a second conversational AI exists among multiple types of conversational AIs that output a response more appropriate to the message than the first conversational AI. The switching unit switches the interlocutor to the second conversational AI when it is determined that the second conversational AI exists. The display control unit identifiably displays information indicating the interlocutor has been switched.

According to a second aspect, an information processing system includes a reception unit, a determination unit, a display control unit, and a switching unit. The reception unit accepts a message input intended for a first conversational AI, which is an interlocutor for a user among multiple types of conversational AIs with different roles. The determination unit that determines whether a second conversational AI exists that outputs more appropriate response to the message than the first conversational AI. The display control unit displays the first conversational AI, which is an interlocutor for the user, in an identifiable manner. When it is determined that the second conversational AI exists, the display control unit displays a screen allowing the user to select whether to switch the interlocutor to the second conversational AI. When switching the interlocutor is selected, the switching unit switches the interlocutor to the second conversational AI. The display control unit identifiably displays information indicating the interlocutor has been switched.

According to a third aspect, in the information processing system of the first aspect or second aspect, wherein each of the plural types of conversational AIs has a prompt that is different sent to the AI to generate a response to the message received by the reception unit.

According to a fourth aspect, in the information processing system of the third aspect, wherein each of the plural types of conversational AIs has a different source for acquiring document data to be included in the prompt.

According to a fifth aspect, in the information processing system of the first aspect to the fourth aspect, wherein the determination unit sends a prompt to the AI that includes the message and the role of each of the plural types of conversational AIs, and the determination unit determines which of the plural types of conversational AIs to switch to based on the response from the AI.

According to a sixth aspect, in the information processing system of the fifth aspect, the prompt includes instruction to select of the conversational AI outputting the appropriate response to the message from among the plural types of interactive AIs.

According to a seventh aspect, in the information processing system of the first aspect to the sixth aspect, the display control unit further displays the response from the second conversational AI to the message.

According to an eighth aspect, in the information processing system of the first aspect to the seventh aspect, the display control unit further displays a screen for interacting with the second conversational AI.

According to a nineth aspect, in the information processing system of the first aspect to the eighth aspect, when the determination unit determines that no second conversational AI outputting more appropriate response than the first interactive AI exists, the display control unit displays the response from the first interactive AI.

According to a tenth aspect, an information processing apparatus includes a display control unit, a reception unit, a determination unit, and a switching unit. The display control unit displays a first conversational AI that is an interlocutor for a user. The reception unit accepts message input directed at the conversational AI. The determination unit determines whether a second conversational AI exists among multiple types of conversational AIs that output a response more appropriate to the message than the first conversational AI. The switching unit switches the interlocutor to the second conversational AI when it is determined that the second conversational AI exists. The display control unit identifiably displays information indicating the interlocutor has been switched.

According to an eleventh aspect, an information processing method executed by a computer includes a first step of displaying, a second step of receiving, a third step of determining, a fours step of switching, and fifth step of displaying. The first step of displaying includes displaying a first conversational AI that is an interlocutor for a user. The second step of receiving includes accepting message input directed at the conversational AI. The third step of determining includes determining whether a second conversational AI exists among multiple types of conversational AIs that output a response more appropriate to the message than the first conversational AI. The fours step of switching includes switching the interlocutor to the second conversational AI when it is determined that the second conversational AI exists. The fifth step of displaying includes displaying information indicating the interlocutor has been switched identifiably.

According to a twelfth aspect, a program executed by a computer includes a first step of displaying, a second step of receiving, a third step of determining, a fours step of switching, and fifth step of displaying. The first step of displaying includes displaying a first conversational AI that is an interlocutor for a user. The second step of receiving includes accepting message input directed at the conversational AI. The third step of determining includes determining whether a second conversational AI exists among multiple types of conversational AIs that output a response more appropriate to the message than the first conversational AI. The fours step of switching includes switching the interlocutor to the second conversational AI when it is determined that the second conversational AI exists. The fifth step of displaying includes displaying information indicating the interlocutor has been switched identifiably.

According to a thirteenth aspect, an information processing system includes a display control unit, a reception unit, a determination unit, and a switching unit. The display control unit displays a first conversational AI that is an interlocutor for a user. The reception unit accepts message input directed at the conversational AI. The determination unit determines whether a second conversational AI exists among multiple types of conversational AIs that output a response more appropriate to the message than the first conversational AI. The switching unit switches the interlocutor to the second conversational AI when it is determined that the second conversational AI exists. The display control unit identifiably displays the information indicating the interlocutor has been switched. The display control unit transmit web content data to a terminal, the web contents data cause to display first web page which includes the first conversational AI and cause to display second web page includes information indicating the interlocutor has been switched. The web contents data also includes first script that cause to transmit the message to the information apparatus and second script that cause to display the second web page. In response to receiving a HTTP request including the message input on the first web page transmitted by execution of the first script, the determination unit determines whether the second conversational AI exists among multiple types of conversational AIs that output a response more appropriate to the message than the first conversational AI. The switching unit switches the interlocutor to the second conversational AI when it is determined that the second conversational AI exists. The display control unit transmit a HTTP response including the information indicating the interlocutor has been switched to display the second web page by executing of the second script.

According to a fourteenth aspect, a terminal includes a display control unit, a reception unit, determination unit, and switching unit. The display control unit displays a first conversational AI that is an interlocutor for a user. The reception unit accepts message input directed at the conversational AI. The determination unit determines whether a second conversational AI exists among multiple types of conversational AIs that output a response more appropriate to the message than the first conversational AI. The switching unit switches the interlocutor to the second conversational AI when it is determined that the second conversational AI exists. The display control unit identifiably displays the information indicating the interlocutor has been switched.

According to a fifteenth aspect, an information processing system comprises an information processing apparatus and a terminal. The information processing apparatus includes a display control unit, a reception unit, a determination unit, and a switching unit. The display control unit displays a first conversational AI that is an interlocutor for a user. The reception unit accepts message input directed at the conversational AI. The determination unit determines whether a second conversational AI exists among multiple types of conversational AIs that output a response more appropriate to the message than the first conversational AI. The switching unit switches the interlocutor to the second conversational AI when it is determined that the second conversational AI exists. The display control unit identifiably displays the information indicating the interlocutor has been switched. The display control unit transmit web content data to the terminal, the web contents data cause to display first web page which includes the first conversational AI and cause to display second web page includes information indicating the interlocutor has been switched. The web contents data also includes first script that cause to transmit the message to the information apparatus and second script that cause to display the second web page. In response to receiving a HTTP request including the message input on the first web page transmitted by execution of the first script, the determination unit determines whether the second conversational AI exists among multiple types of conversational AIs that output a response more appropriate to the message than the first conversational AI. The switching unit switches the interlocutor to the second conversational AI when it is determined that the second conversational AI exists. The display control unit transmit a HTTP response including the information indicating the interlocutor has been switched to display the second web page by executing of the second script. The terminal includes a second reception unit, a second display control unit, a execution unit, and a transmission unit. The second reception unit receives the web content data. The second display control unit display the first web page on the screen. The execution unit executes the scripts included in the web contents data. The transmission unit includes the HTTP request including the message to the information processing apparatus. The reception unit receives the HTTP response. The second display control unit display the information indicating the interlocutor has been switched.

1. An information processing system, comprising:
an information processing apparatus; and
a terminal,
the information processing apparatus comprising first circuitry configured to:
transmit web content data to the terminal, the web content data to cause a display of a first web page and a second web page, the first web page displaying a first conversational AI identifiably as an interlocutor, wherein the web content data includes a first script which causes the terminal to transmit a message input in the first web page and a second script which causes the terminal to display information indicating that the interlocutor is switched;
determine a second conversational AI to output an alternative response to the message in response to receiving a Hypertext Transfer Protocol (HTTP) request including the message from the terminal, the HTTP request being transmitted in response to execution of the first script;
switch the interlocutor from the first conversational AI to the second conversational AI based on the message; and
transmit an HTTP response, to the terminal, including the information indicating that the interlocutor is switched;
the terminal comprising second circuitry configured to:
receive the web content data from the information processing apparatus;
display the first web page, based on the web content data, the first web page including the first conversational AI as the interlocutor in communication with a user among a plurality of types of conversational AIs;
receive the message from the user via the first web page;
transmit the HTTP request including the message in response to executing the first script included in the web content data;
receive the HTTP response from the information processing apparatus including the information indicating that the interlocutor is switched; and
display the second web page based on the web content data in response to executing the second script, the second web page including information indicating the interlocutor is switched.

2. The Information processing system according to claim 1, wherein the first circuitry is further configured to:
transmit, to the terminal, in response to determining the second conversational AI, a screen input selection of whether to switch the interlocutor to the second conversational AI.

3. The Information processing system according to claim 1, wherein:
each of the plurality of types of conversational AIs related with a different prompt that is sent to the AI system to generate a response to the message.

4. The Information processing system according to claim 3, wherein:
each of the plurality of types of conversational AIs is related to a different document data source is included in the prompt that is sent to the AI system to generate the response to the message.

5. The Information processing system according to claim 1, wherein the first circuitry is further configured to:
send a prompt including the message and each role of the plurality of conversational AIs to the AI system, and determine whether there is a second interactive AI that outputs the alternative response as compared to a response from the first conversational AI.

6. The Information processing system according to claim 5, wherein:
the prompt instructs to select the second conversational AI that outputs the alternative response from among the plurality of conversational AIs.

7. The Information processing system according to claim 5, wherein the second circuitry is further configured to:
display a response message as a message from the second conversational AI in response to the message input by the user.

8. The Information processing system according to claim 5, wherein the second circuitry is further configured to:
display a screen for interacting with the second conversational AI.

9. The Information processing system according to claim 1, wherein the second circuitry is further configured to:
display a response message from the first conversational AI, in response to determining that there is no second conversational AI that can output a more appropriate response than the first dialogue AI.

10. An information processing method, comprising:
transmitting web content data to a terminal, the web content data to cause a display of a first web page and a second web page, the first web page displaying a first conversational AI identifiably as an interlocutor, wherein the web content data includes a first script which causes the terminal to transmit a message input in the first web page and a second script which causes the terminal to display information indicating that the interlocutor is switched;
determining a second conversational AI to output an alternative response to the message, in response to receiving a Hypertext Transfer Protocol (HTTP) request including the message from the terminal, the HTTP request being transmitted in response to execution of the first script;
switching the interlocutor from the first conversational AI to the second conversational AI based on the message; and
transmitting an HTTP response, to the terminal, including the information indicating that the interlocutor switched.

11. The information processing method according to claim 10, further comprising:
transmitting, to the terminal, in response to determining the second conversational AI, a screen input selection of whether to switch the interlocutor to the second conversational AI.

12. The information processing method according to claim 10, wherein:
each of the plurality of types of conversational AIs related with a different prompt that is sent to the AI system to generate a response to the message.

13. The information processing method according to claim 12, wherein:
each of the plurality of types of conversational AIs is related to a different document data source is included in the prompt that is sent to the AI system to generate the response to the message.

14. The information processing method according to claim 10, further comprising:
sending a prompt including the message and each of the roles of the plurality of conversational AIs to the AI system; and
determining whether there is a second interactive AI that outputs the alternative response as compared to a response from the first conversational AI.

15. The information processing system according to claim 5, wherein:
the prompt instructs to select the second conversational AI that outputs the alternative response from among the plurality of conversational AIs.

16. The information processing method according to claim 14, further comprising:
displaying a response message as a message from the second conversational AI in response to the message which is input by a user.

17. The information processing method according to claim 14, further comprising:
displaying a screen for interacting with the second conversational AI.

18. The information processing method according to claim 10, further comprising:
displaying a response message from the first conversational AI, in response to determining that there is no second conversational AI that can output a more appropriate response than the first dialogue AI.

19. A terminal, comprising circuitry configured to:
display a first web page including a first conversational AI identifiably as an interlocutor;
receive a message input by a user;
determine a second conversational AI, which outputs an alternative response to the message different from a response of the first conversational AI;
switch the interlocutor from the first conversational AI to the second conversational AI based on the message; and
display a second web page including information indicating the interlocutor including the second conversational AI.

20. The terminal according to claim 19, further comprising:
displaying a screen for the user to select the second conversational AI.
